(19) United States
(12) Patent Application Publication
(10) Pub. No.: US 2024/0164570 A1
(43) Pub. Date: May 23, 2024

(54) GROUP HEAD FOR AN ESPRESSO MACHINE

(71) Applicant: Breville Pty Limited, Alexandria (AU)

(72) Inventors: Mark Lewis HOLLOWAY, Alexandria (AU); Alper BENDER, Alexandria (AU); Man Ho HAN, Alexandria (AU); Chiu Keung Kenneth LEE, Alexandria (AU); Con PSAROLOGOS, Alexandria (AU); Xiang REN, Alexandria (AU); Alexander Lee Thomas CHUDLEY, Alexandria (AU)

(73) Assignee: Breville Pty Limited, Alexandria (AU)

(21) Appl. No.: 18/551,433

(22) PCT Filed: Mar. 24, 2022
(86) PCT No.: PCT/AU2022/050268

§ 371 Date: Sep. 20, 2023

(30) Foreign Application Priority Data
Mar. 24, 2021 (AU) 2021900875

(51) Int. Cl. A47J 31/46; A47J 31/36

(52) U.S. Cl. CPC A47J 31/46; A47J 31/3671

(57) ABSTRACT

A group head (20) for an espresso machine (10), the group head (20) comprising:
a group head bracket (36) for detachable engagement with a portafilter (30) holding a puck (22) of ground coffee in a filter basket (64) to dispense an espresso coffee;
   a conduit (34) for receiving a flow of water to the portafilter (30); and,
   a heater (32) mounted in the group head (20) to heat the flow of water to the portafilter (30).

### FIELD

The invention relates to espresso machines. In particular, the invention relates to controlling the temperature of brew water passing through the ground coffee.

### BACKGROUND

Espresso coffee is made by passing hot water, under pressure, through compressed coffee grounds. Conventionally, the coffee grounds are placed in a filter equipped with a handle (known as a portafilter) which detachably connects to the espresso machine at the ‘group head’ (GH). To improve the flavour of the coffee by ground, the grounds are compacted or compressed into the portafilter such that it forms a disc known as a ‘puck’.

For optimum expresso extraction quality, the espresso machine first heats the water before forcing it through the puck under pressure. The optimum temperature for the “brew water” (as it is called) for the required espresso quality will vary somewhat depending on various factors such as the coffee beans, the grind (i.e. how finely the roasted beans are ground) as well as user preference. However, typically the optimum temperature will fall within the range of 90° ° C. to 95° C.

Espresso machines will normally heat the brew water with a main heater in a boiler, and/or using a thermoblock upstream of the portafilter. A thermoblock is a metallic block (typically cast aluminium) with an internal flow path and a resistive heater element. Water flowing through the thermoblock is conductively heated by the internal surfaces of the flow path. Unfortunately, these heating mechanisms can be slow to heat the brew water to the required temperature because of their physical mass and thermal properties. During this time, the temperature of the brew water is not controllable for a short period of the coffee extraction process. As discussed above, coffee extraction with water that is not at the correct temperature is detrimental to the espresso.

Thermoblock heaters have associated manufacturing and materials issues. Casting the aluminium thermoblocks requires surface coatings for beverage-making to resist corrosion. Cast aluminum in direct contact with water and heat will corrode, therefore it needs to be coated (e.g. Teflon or another) to prevent the oxidation happening. Aluminum has a relatively high specific heat capacity requiring more energy to heat up (compared to, say, stainless steel or brass) and hence takes longer to heat to a particular temperature. Aluminium also has a relatively high thermal conductivity so it dissipates heat quicker than stainless steel. The castings are porous and this can make the manufacturing less repeatable and robust. The thermoblock castings also tend to be relatively large and heavy which is counter to the aim of a compact overall design.

The water heated by the main heater becomes a ‘heat medium’ that transfers heat into adjacent components and the ambient environment throughout the machine. This conductive and radiant heating can be uneven and cause inconsistencies in the temperature of the group head and water flow. Notwithstanding this, the main heater in the boiler is relied on to heat up the machine over time and reduce the temperature loss of the brew water as it flows through various conduits pipes, fittings, valves and connectors. While this can help limit temperature losses, the brew water temperature is still not well controlled.

The temperature profile across the flow path of water will also vary. Current heaters such as thermoblocks and boilers can be characterised as a flow through system. The water flows through the boiler and the thermoblock at a relatively high flowrate which causes uneven water heating. Water closer to the internal surfaces of the thermoblock with typically have a higher temperature than water towards the centre of the flowpath. These discrepancies between the actual and optimal brew water temperatures can noticeably detract from the expresso extraction quality.

### SUMMARY OF INVENTION

It is an object of the present invention to address one or more of the above discussed disadvantages, or at least provide a useful alternative to the above-mentioned approaches.

In one aspect, the present invention provides a group head for an espresso machine, the group head comprising:
a group head bracket for detachable engagement with a portafilter holding a puck of ground coffee in a filter basket to dispense an espresso coffee;
a conduit for receiving a flow of water to the portafilter; and,
a heater mounted in the group head to heat the flow of water to the portafilter.

Preferably, the group head further comprises a flow diffuser adjacent the heater to define a space to spread the flow of water from the conduit across a surface of the heater to enhance conductive heating.

Preferably, the diffuser has a plurality of channels for directing the flow of water across the surface of the heater, the channels having channel walls that abut the surface of the heater for heat conduction into the diffuser.

Preferably, each of the channels is in fluid communication with the conduit for receiving the flow of water, and each of the channels having at least one outlet for fluid communication with the portafilter.

Preferably, the group head further comprises a screen positioned between the outlets of the channels and the portafilter, the outlets being arranged such that the flow of water through the screen to the portafilter has a desired distribution across the puck of ground coffee.

Preferably, the diffuser is formed of corrosion-resistant material with high specific heat capacity.

Preferably, the heater is mounted in the group head bracket for heat conduction from the heater to the group head bracket.

Preferably, the detachable engagement between the group head bracket and the portafilter is configured for heat conduction from the group head bracket to the portafilter.

Preferably, the heater is a resistive heater with a conductive path of electrically resistive material.

Preferably, the resistive heater is adjustable for heating the flow of water to a predetermined temperature.

Preferably, the predetermined temperature is a user selected temperature

Preferably, the group head further comprises further comprising a temperature sensor for feedback control of the resistive heater.

Preferably, the resistive heater is a thick film heater with the electrically resistive material deposited as a thick film on a substrate.

Preferably, the thick film heater surrounds at least one section of the conduit.

Preferably, the thick film heater is a disc arranged such that during use, the disc extends in a plane generally parallel to a top surface of the puck.

Preferably, the conduit has an outlet in the centre of the disc and the channels of the diffuser are configured to radially spread the water flow across the surface of the disc.

Preferably, the thick film heater is configured to heat the water flow through the group head to a temperature between 89° C. and 96° C.

Preferably, the thick film heater is configured to heat the flow of water drawn from a reservoir within an espresso machine, to between 89° ° C. and 96° C. in less than 10 seconds from activation of the thick film heater.

Preferably, the group head includes a chamber defined by internal walls of the group head, the chamber having an aperture for receiving the portafilter, and wherein the heater is mounted to the chamber.

In a further aspect, the invention provides an espresso machine having a group head as described above in relation to the first aspect and related preferred features.

In another aspect, the invention provides a method for producing an espresso coffee comprising the steps of:
placing a puck of coffee grounds within a filter basket of a portafilter;
attaching the portafilter to a group head of an espresso machine, the group head having a heater and a conduit for a flow of water to the portafilter;
providing a flow of water through the conduit to the puck of coffee grounds; and,
heating the flow of water through the group head with the heater.

Preferably, the heater is a resistive heater having a conductive path of electrically resistive material.

Preferably, the method further comprises the step of adjusting electrical power to the resistive heater to heat the flow of water from the group head to a predetermined temperature. In some forms, the predetermined temperature is user selected.

Preferably, the method further comprises the step of providing a temperature sensor for feedback control of the resistive heater by a control unit within the espresso machine.

Preferably, the heater is formed to surround at least one section of the conduit.

Preferably, the resistive heater is a thick film heater with electrically resistive material deposited as a thick film on a substrate.

Preferably, the thick film heater is formed as a disc extending in a plane generally parallel to a top surface of the puck.

Preferably, the method further comprises providing the group head with a flow diffuser adjacent the heater to define a space to spread the flow of water from the conduit across a surface of the heater to enhance conductive heating.

Preferably, the diffuser has a plurality of channels for directing the flow of water across the surface of the heater, the channels having channel walls that abut the surface of the heater for heat conduction into the diffuser.

Preferably, each of the channels is in fluid communication with the conduit for receiving the flow of water, and each of the channels having at least one outlet for fluid communication with the portafilter.

Preferably, the method further comprises the step of providing a screen between the outlets of the channels and the portafilter, and arranging the outlets such that the flow of water through the screen to the portafilter has a desired distribution across the puck of ground coffee.

Preferably, the method further comprises the step of providing a group head bracket for mounting the group head to the espresso machine wherein the heater is mounted in the group head bracket for heat conduction from the heater to the group head bracket.

Preferably, the detachable engagement between the group head bracket and the portafilter is configured for heat conduction from the group head bracket to the portafilter.

Preferably, the method further comprises the step of configuring the thick film heater to heat water flowing from the group head to a temperature between 89° ° C. and 96° C.

Preferably, the method further comprises the step of configuring the thick film heater to heat the water flowing through the group head to at least 89ºC in less than 10 seconds from activation of the thick film heater.

Preferably, the diffuser is formed of corrosion-resistant material with high specific heat capacity.

### BRIEF DESCRIPTION OF DRAWINGS

The invention will now be described by way of example only with reference to the following illustrative embodiments and the accompanying drawings, in which:

FIG. 1 is a schematic diagram of an espresso machine according to the present invention:

FIG. 2 is a perspective view of a group head according to the present invention:

FIG. 3 is a cross section of a portafilter detachably engaged with a group head according to the present invention:

FIG. 4 is a cross section of the group head of FIG. 3 in isolation:

FIG. 5 is a diagrammatic cross section of the group head engaged with the portafilter showing the flow of brew water and the heat conduction through the group head to the portafilter:

FIG. 6 is a perspective of the water conduit and the heater of FIG. 4 in isolation:

FIG. 7 is a perspective of the inner bracket of the group head and the conduit surrounded by the heater, in isolation;

FIG. 8 is a perspective of the inner bracket with conduit and heater together with the terminal bracket and the temperature sensor for operating the heater:

FIG. 9 is an exploded perspective showing the inner bracket of the group head together with the terminal bracket for the heater, and temperature sensor, with the diffuser, shower screen, and central attachment screw beneath the inner bracket:

FIG. 10 is an exploded perspective showing the components of the group head:

FIG. 11 is a section view of an espresso machine with portafilter detachably engaged with the group head in accordance with the present invention:

FIG. 12 is a partial, cutaway perspective of the espresso machine shown in FIG. 11:

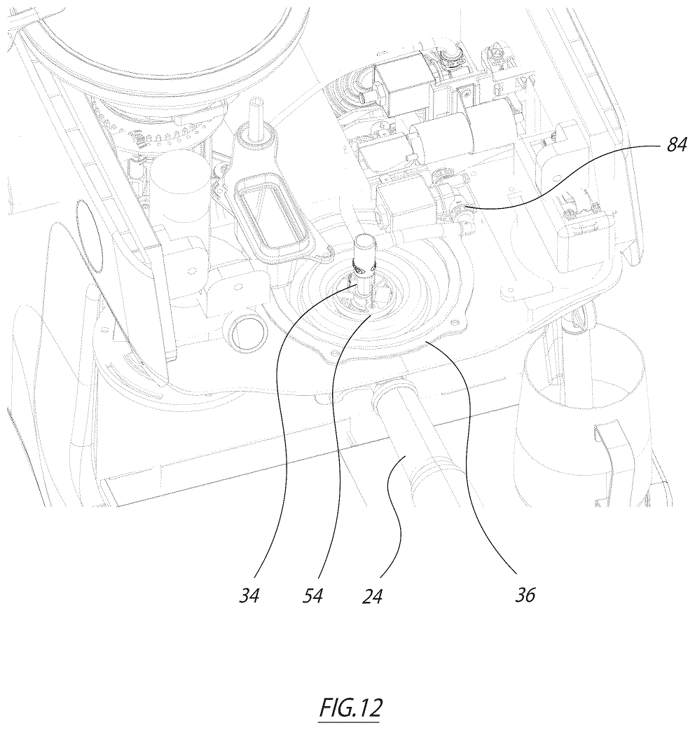

FIG. 13 is a graph of the brew water temperature and pressure at the group head inlet and outlet during the preparation of an espresso coffee; and

FIG. 14 is a flow chart of the operation of an espresso machine with a group head according to the present invention.

### DESCRIPTION OF EMBODIMENTS

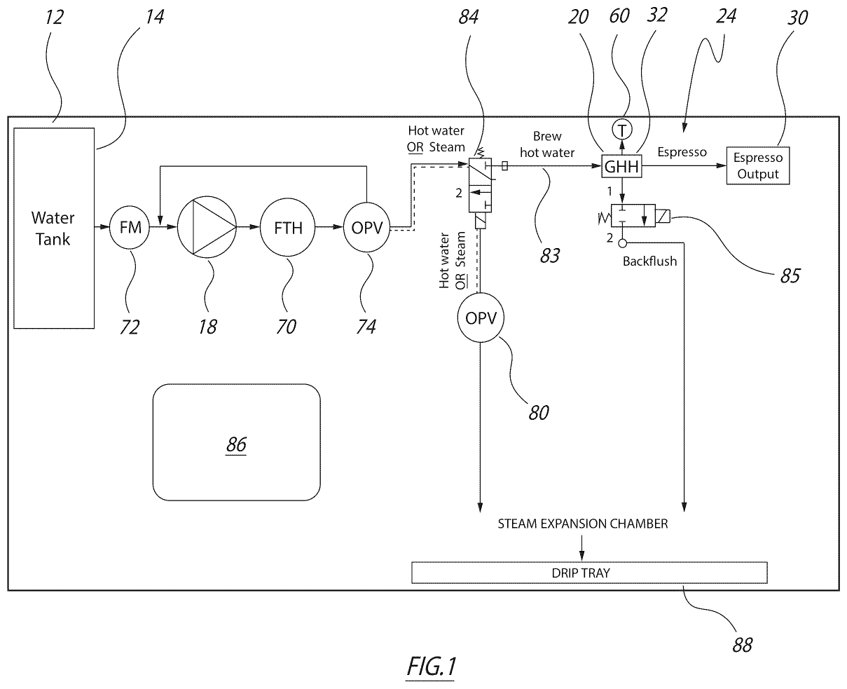

Referring to the Figures, the main components of an espresso machine 10 according to the present invention is schematically shown in FIG. 1. As a standalone machine 10, water 12 is drawn from a water reservoir 14 by the flow-through pump 18 to raise the water pressure to around 9 bar, and up to a maximum of 15 bar. A flow meter 72 at the reservoir outlet provides a flowrate feedback signal to the controller 86.

The pump 18 feeds water to the flow through heater 70 to raise the water temperature to around 120° C. The heated water flows onto solenoid valve 84. The user selects (via the user interface) espresso extraction, hot water output (e.g. for long blacks etc) or steam output for milk frothing. When the machine 10 is not operating, the valve 84 is biased to direct flow to the drip tray 88 to clear any residual water under pressure. Similarly, an over pressure valve 80 vents to the drip tray 88 should the water pressure exceed a safe maximum.

In the interests of clarity, only the espresso extraction flow line 83 is shown. With the extraction flow line 83 opened by the solenoid valve 84 the heated water at about 9 bar pressure flow to the group head 20. The temperature of the water is no longer the temperature at the outlet of the flow through heater 70. Heat dissipation into the conduits, valves connectors and fittings drops the temperature in a manner that is difficult to actively control via feedback control of the flow through heater 70. Some espresso machines use a thermoblock heater upstream of the group head to improve temperature control of brew water through the portafilter 24. However, as discussed above, thermoblock heaters have a relatively large thermal mass that makes precise control of the brew water temperature difficult. Furthermore, if the brew water temperature at the outlet of the thermoblock heater is well controlled, there are still losses along the flow path to the group head and through the group head itself.

To address this, the Applicant's use a group head heater 32 incorporated in the group head 20. As described in greater detail below; the group head heater 32 provides greater control of the brew water temperature entering the portafilter 24. Brew water below the required temperature is rapidly heated to remove any significant fluctuations for the duration of the extraction process. Maintaining the brew water temperature at the required temperature (say) 93° ° C. discernably improves the quality of the extracted espresso 30. A temperature sensor 60 may provide output to the processor 86 for feedback control of during the extraction process and for a safety shut off in the event of a maximum temperature (say, around 200° ° C. to 220° C.).

After espresso extraction, the brew water flow to the portafilter 30 is shut off. If the user wishes, a back flush valve 85 is used to flush clean the group head and drain water to the drip tray 88. The water pressure and temperature upstream of the group head can drop and draw in a small amount of the extracted coffee back from the portafilter. The back flush to the drip tray removes any residue and prepares the group head for the next extraction.

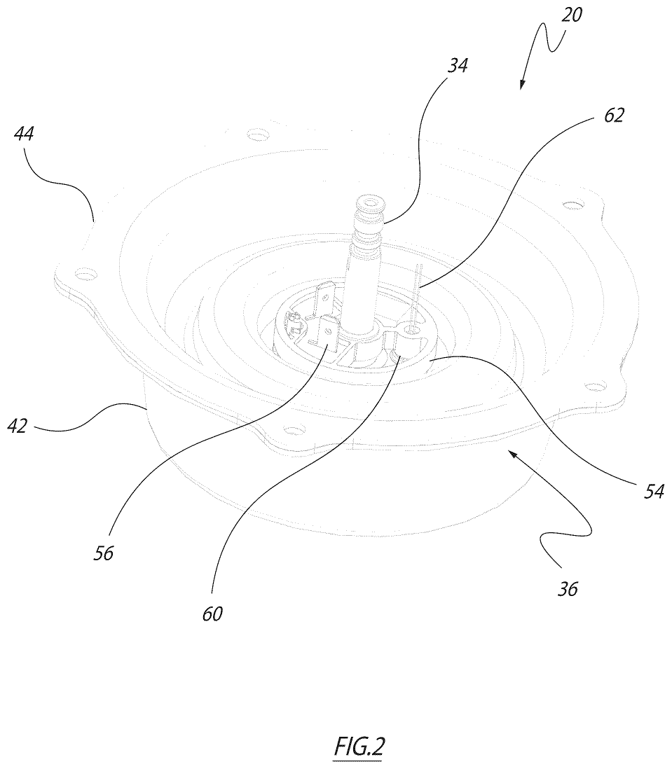

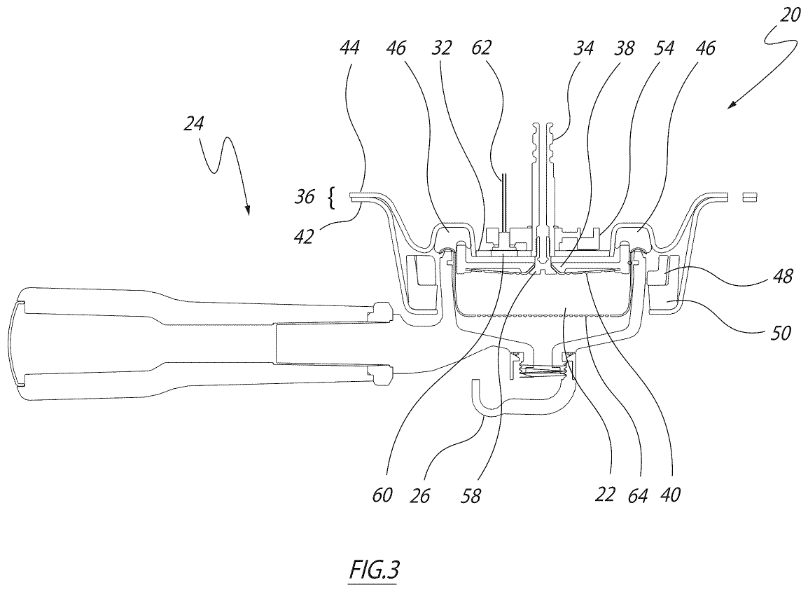

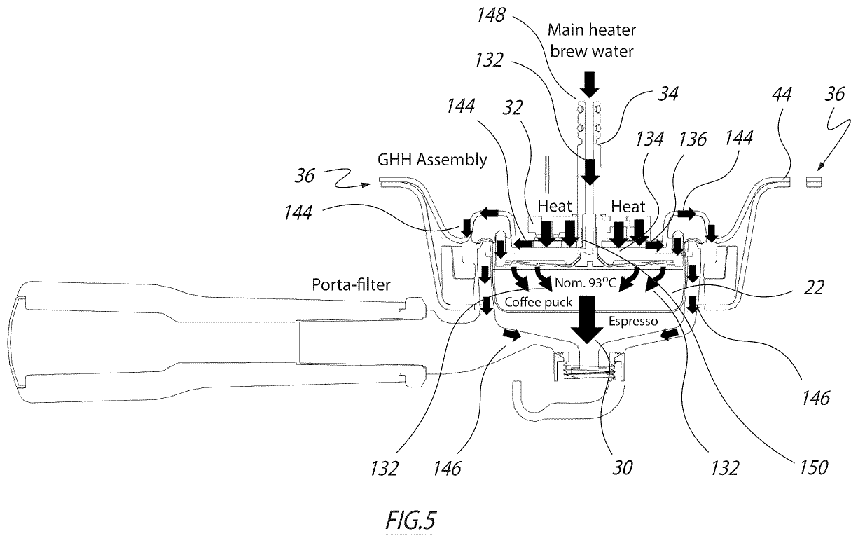

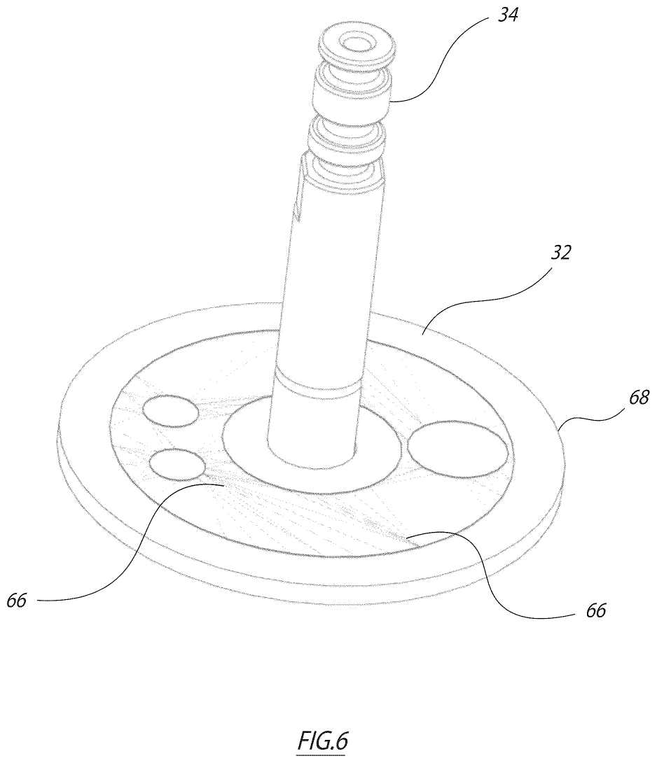

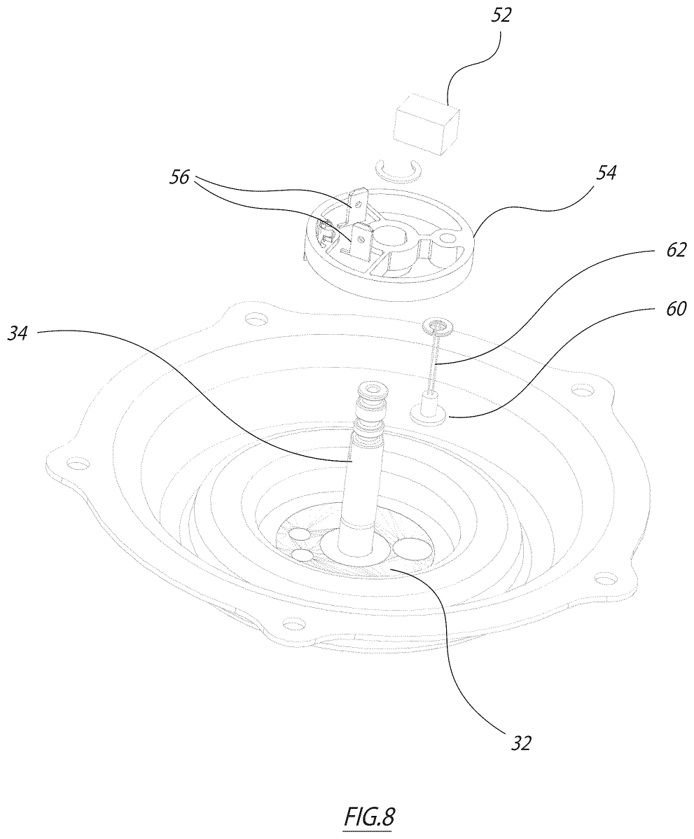

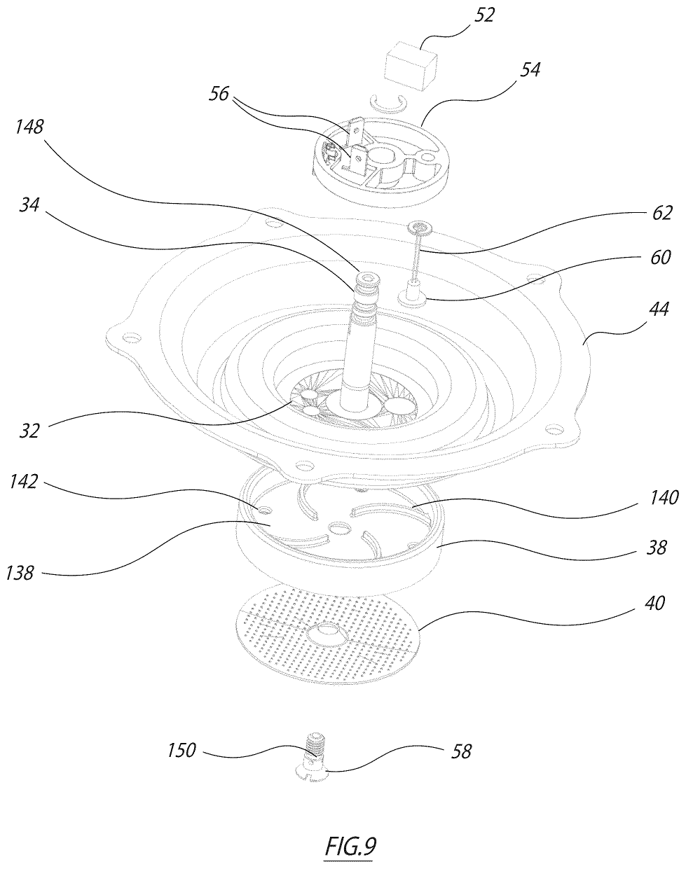

The complete group head 20 is shown in FIGS. 2, 4 and 10. FIG. 5 is a schematic section view of the portafilter engaged with the group head assembly showing the heat conduction from the GH heater 32 to the group head 20, the portafilter 24 and the brew water flow to the puck 22. FIGS. 6 to 9 show particular sub-assemblies and components in isolation in the interests of clarity, while FIG. 3 shows the group head 20 detachably engaged with the portafilter.

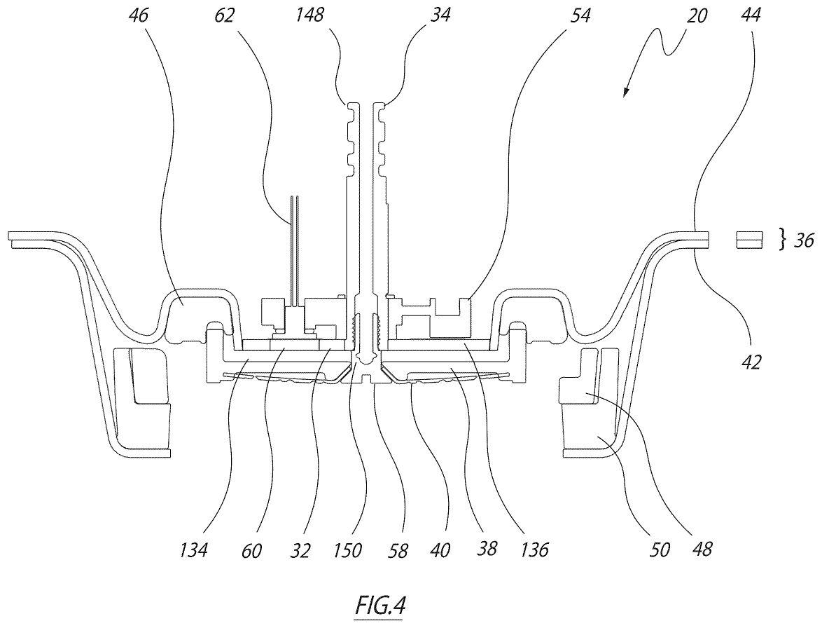

The group head 20 mounts to the body of the espresso machine 10 via a group head bracket 36 and includes a chamber defined by internal walls of the group head, the chamber having an aperture for receiving the portafilter 30. The group head bracket 36 is an assembly of an inner bracket 44 and an outer bracket 42 (see FIG. 4). The inner bracket 44 mounts the GH heater 32 to the chamber and holds the GH heater 32 closely adjacent the upstream side of the diffuser 38. The GH heater 32 is formed as a disc with a central aperture surrounding the conduit 36 for receiving brew water from the solenoid valve 84. As best shown in FIGS. 4 and 5, the GH heater 32 and the diffuser 38 define a space 134 that extends horizontally across the downward facing surface 136 of the GH heater 32. The flow 132 of brew water through the conduit 34 enters the horizontal space 134 through conduit outlets 150 formed in the center screw 58 threaded into the lower end on the conduit 34 (described further below). The brew water flow 132 is directed across the surface 136 of the GH heater 32 by the diffuser 38. The space 134 is dimensioned such that all water in the flow 132 is kept close to the heater surface 136 and rapidly heated.

As best shown in FIG. 5, the group head 20 and the diffuser 38 are also configured to be conductively heated by the GH heater 32. To promote this, the group head bracket 36 and the diffuser 38 have high heat conductivity, and preferably formed from materials with high specific heat capacity and corrosion-resistance such as stainless steel. The heat conduction 144 through the group head bracket 36 will in turn heat the diffuser 38 which also has high specific heat capacity and corrosion-resistance (e.g. stainless steel). Heating the diffuser 38 assists heat conduction into the brew water flow 132 through the space 134.

The diffuser 38 has channels 138 defined by channel walls 140 that abut the surface 136 of the GH heater 32. This contact with the GH heater 32 further promotes heat conduction into the diffuser 38. The channels 138 each have at least one diffuser outlet 142 for fluid communication to the shower screen 40. The number and arrangement of the diffuser outlets 142 are such that the flow of brew water through the shower screen 40 has a desired distribution. Normally, the diffuser outlets 142 are configured for a relatively uniform flowrate and temperature which in turn provides an even flow distribution through the shower screen 40 onto the puck 22 for a better coffee extraction with evenly and accurately heated water.

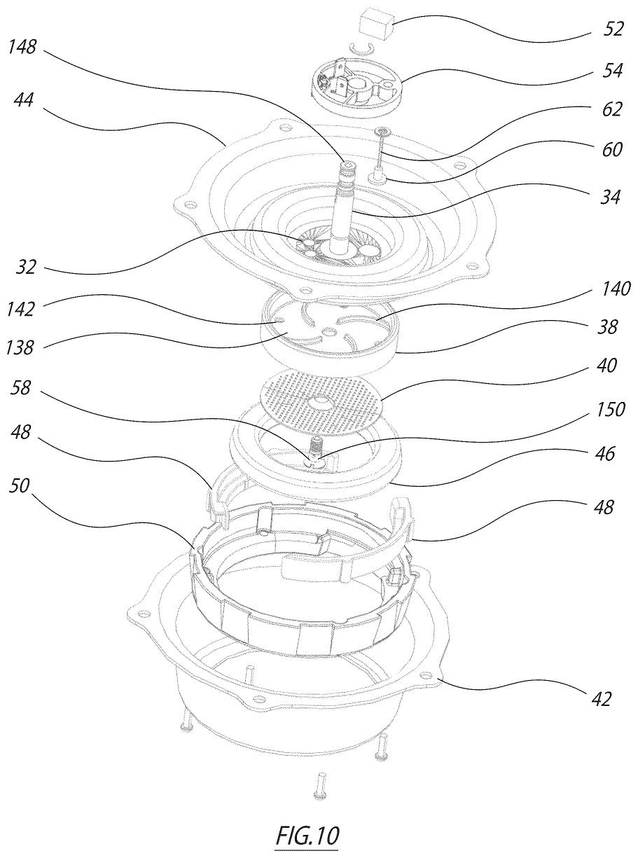

As shown in FIGS. 4 and 10, the center screw 58 threads into the end of the conduit 34 to hold the shower screen 40 and the diffuser 38 in place. The shank of the center screw 58 is hollow with the axial bore leading to two holes through the side of the shank which form the outlet 150 of the conduit 34. Brew water from the solenoid valve 84 flows into the conduit inlet 148 and out the outlets 150 into the space 134 between the GH heater 32 and the diffuser 38. The water radially disperses to fill the space 134 which is sealed at the periphery of the diffuser 38 by the GH seal 46. The volume of this space is relatively low compared to the area of underside surface 136 to enhance heat conduction into the water. As the space is narrow, the water temperature is relatively uniform. Forming the heater 32 such that it surrounds part of the conduit 34 also assists in rapid heat conduction into the water. From initial activation of the pump 18, to water flow from the group head 20 to the coffee puck 22 at a temperature between 89° ° C. to 96° C., is less than 10 seconds.

As discussed above, the brew water flow from each diffuser outlet 142 onto the shower screen 40 is relatively uniform (in terms of temperature and flowrate). The water spreads across the apertured shower screen 40 before evenly passing through to the upper surface of the puck 22 (see FIG. 3). The puck 22 is held in the filter basket 64 of the portafilter 24. The top of the filter basket 64 also seals against the GH seal 46 to prevent leakage of brew water and ensure infusion through the puck 22 remains at the correct water pressure (around 9 bar).

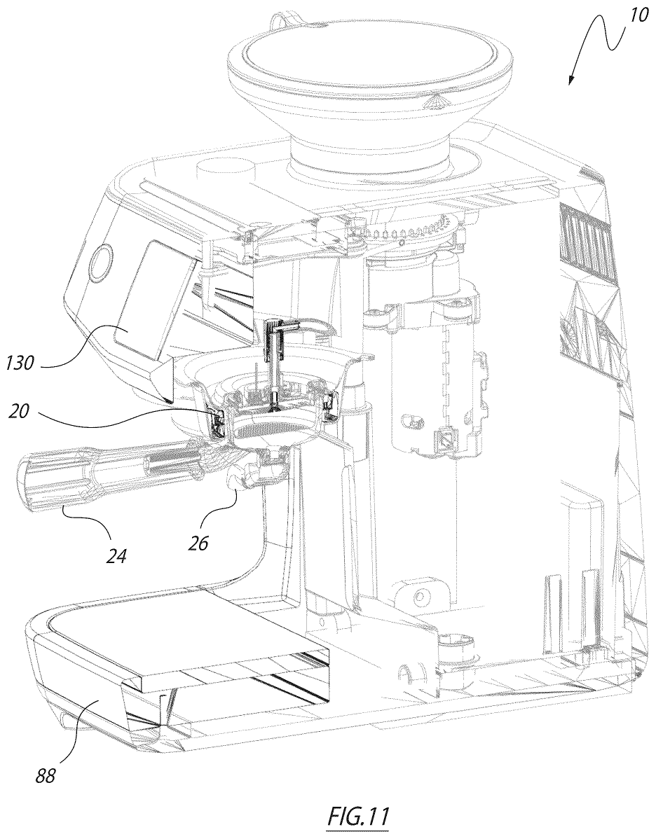

The extracted espresso coffee flows out of the filter basket 64 and into the spout 26 where it drains into a coffee cup placed on the drip tray 88. The control unit 86 can determine the volume of the dose according to the cup 28, or the user may manually control the dose volume by deactivating the pump 18 and/or solenoid valve 84 via the user interface 130 (see FIG. 11).

After extracting the espresso dose, the portafilter 24 is detached from the group head 20 to remove the wet puck 22. The portafilter 24 detachably connects to the group head 20 via a bayonet fitting. Diametrically opposed lugs (not shown) on either side of the portafilter 24 slide upwards through recesses in the radially inner surface of the insert 50 within the outer bracket 42 of the group head 20 (see FIG. 10). The insert 50 holds a pair of guides 48 which each define a surface for sliding engagement with one of the lugs of the portafilter 24 using removable guides 48 allow the group head 20 to be easily adapted for replacement without taking the group head apart. The insert holds the guides 48 in the correct position between the outer bracket 42 and the inserted portafilter 24. Optionally, the insert 50 can be an integral part of the outer bracket 42.

The guides 48 are configured such that sliding the lugs to the engaged position also urges the portafilter 24 upwards so the top of the filter basket 64 is pressed into sealing engagement with the GH seal 46.

The GH heater 32 is best shown in FIG. 5. The GH heater 32 is formed of a disc mounted in the group head 20. Optionally, the GH heater 32 and the inner bracket 44 may be formed as an integral component. The disc is a thick film heater in which conductive paths of electrically resistive material 66 are deposited on a substrate 68.

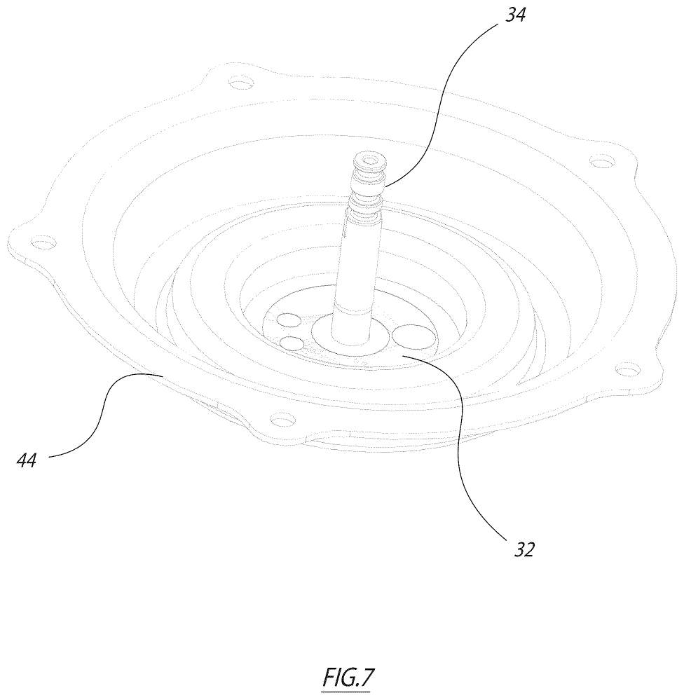

The conductive paths 66 of electrically resistive material are energized via the electrical terminals 56 held in the connector bracket 54 (see FIG. 7). For the purposes of feedback control, the heater is provided with a negative temperature coefficient (NTC) thermistor 60 connected to the control unit 86 via conductors 62. A thermal fuse 52 is also provided on the bracket 54 as a fail safe to guard against overheating.

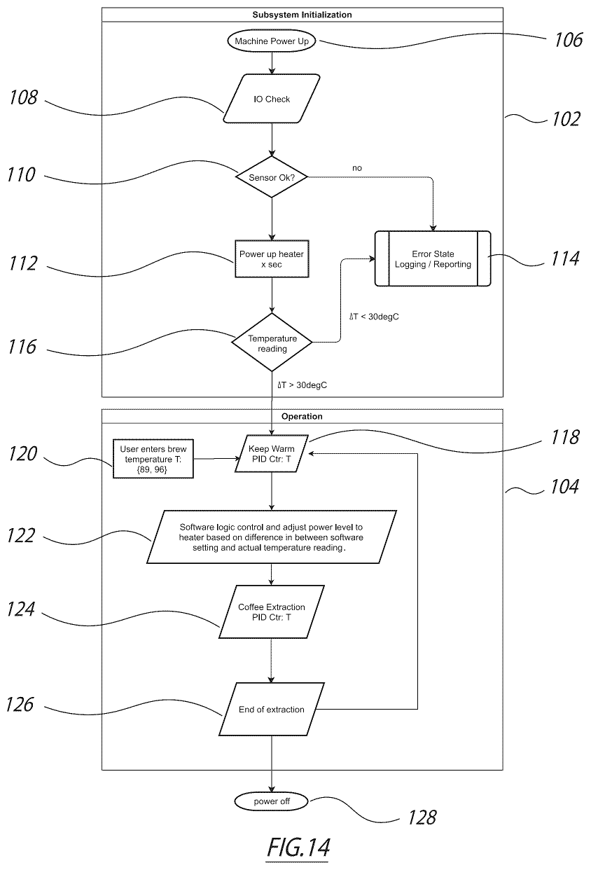

The operation of the espresso machine 10 will now be described with particular reference to the flow chart shown in FIG. 14. However, as a preliminary step, the user adds a puck 22 of ground coffee into the portafilter 24 and attaches the portafilter to the group head 20 via the bayonet coupling discussed above. A coffee cup is place on the drip tray 88 beneath the spout 26 (see FIG. 1).

As shown in FIG. 14, the operation of the espresso machine involves a sub system initialization 102 prior to an espresso extraction operation 104. The sub system initialization 102 begins with the user-initiated power up 106 via the interface 130 (see FIG. 11). In some examples, other inputs are selected via the interface 130 such as single or double shot and/or preferred brew water temperature.

Upon power up 106, the control unit 86 performs a diagnostic check 108 of the inputs and outputs associated with the sensors, pumps and heaters. If the diagnostic check 108 identifies an error, the control unit 86 logs and reports the error state 114. If the control unit 86 makes a determination 110 that the diagnostic check is clear, the GH heater 32 is activated for predetermined period 122 (for example, 8 seconds to 12 seconds). After the predetermined period, the change in temperature of the GH heater 32 is measured. In the event the temperature change is less than a predetermined amount (for example, 30° C. change) the control unit 86 logs and reports an error state 114. If the temperature increase of the GH heater 32 meets or exceeds the predetermined amount, the sub system initialization 102 is complete and the espresso extraction 104 process may commence.

The GH heater 32 and the group head 20 is kept warm at step 118 via feedback control set to a predetermined temperature. To commence the extraction process, the user opens the outlet valve 84 to initiate the flow of brew water at step 124 via the user interface 130. At this stage, the control unit 86 may increase the power to the GH heater 32 for a short period of time to compensate for a drop in the temperature of the brew water at the start of the extraction process. Similarly, if the NTC thermistor 60 on the GH heater 32 indicates a temperature drop during the extraction process, the power to the heater is increased to compensate. Likewise, the feedback from the thermistor 60 is used to keep the GH heater 32 and therefore the brew water under a maximum temperature. For example, if the water temperature is higher than the user-selected brewing temperature (via the user interface at step 120), the power to the heater is decreased.

Once the control unit 86 makes the determination 126 that the required dose volume has been dispensed, the brew water flow is stopped. The pump deactivates and the outlet valve from the reservoir 14 closes. At this stage the machine reverts to maintaining the heater and group head temperature at step 118.

When no more espressos are required, the espresso machine is powered off 128 by the user via the interface 130 and/or it may automatically turn off after a predetermined period of inactivity.

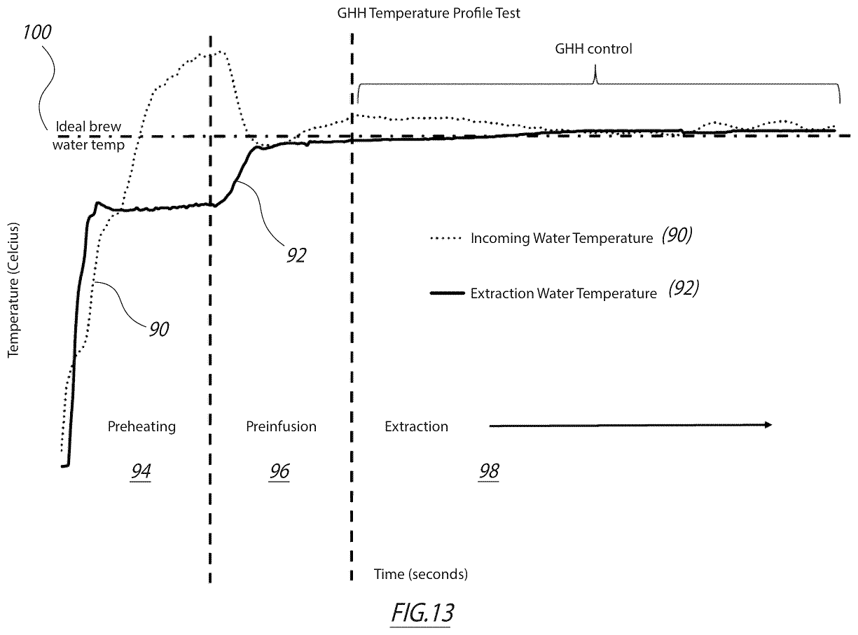

FIG. 13 is a plot showing the enhanced temperature control of brew water provided by incorporating a GH heater 32 into group head 20. Incoming water temperature 90 (i.e. water temperature at conduit inlet 148), and extraction water temperature 92 (i.e. temperature of water through the shower screen 40) are plotted for all coffee extraction phases, namely preheating 94, pre-infusion 96 and extraction 98.

Water temperature plots demonstrate the functionality of the group head. Incoming water 12 (see FIG. 1) is heated by water heater 70 and then fed to the group head 20, which uses temperature feedback to control power to the GH heater 32. The group head inlet temperature 90 initially heats quickly during the pre-heat phase 94 and exceeds the ideal temperature 100. However, heat dissipates into the structures of the group head, conduits, valves and connectors which drops the brew water temperature below the ideal temperature 100. The group head heater 32 rapidly raises the brew water temperature in response to feedback from the NTC thermistor 60. Algorithmic feedback control by the control unit 86 effectively damps the temperature discrepancies in the incoming temperature 90 and maintains the GH outlet temperature 92 at, or near, the ideal temperature 100. Initially, the GH outlet temperature 92 oscillates slightly when the ideal temperature 100 is reached but then closely follows the ideal temperature 100 during the extraction phase 98. In contrast, the GH inlet temperature 90 continues to have greater variations.

Controlling this aspect of the extraction process has a direct bearing on the quality of the espresso 30 dispensed to the cup.

In some embodiments, the espresso machine 10 only has a GH heater 32. This allows for compact and less expensive machines for users that do not require the milk frothing functionality for milk coffees. These single GH heater embodiments require little bench space and will provide quality single and double shot espressos in a very short time.

The invention has been described herein by way of example only. Skilled workers in this field will readily recognise many variations and modifications which do not depart from the spirit and scope of the broad inventive concept.

1. A group head for an espresso machine, the group head comprising:
a group head bracket for detachable engagement with a portafilter holding a puck of ground coffee in a filter basket to dispense an espresso coffee:
a conduit for receiving a flow of water to the portafilter; and,
a heater mounted in the group head to heat the flow of water to the portafilter.

2. A group head according to claim 1 further comprising a flow diffuser adjacent the heater to define a space to spread the flow of water from the conduit across a surface of the heater to enhance conductive heating.

3. A group head according to claim 2 wherein the diffuser has a plurality of channels for directing the flow of water across the surface of the heater, the channels having channel walls that abut the surface of the heater for heat conduction into the diffuser.

4. A group head according to claim 3, wherein each of the channels is in fluid communication with the conduit for receiving the flow of water, and each of the channels having at least one outlet for fluid communication with the portafilter.

5. A group head according to claim 4 further comprising a screen positioned between the outlets of the channels and the portafilter, the outlets being arranged such that the flow of water through the screen to the portafilter has a desired distribution across the puck of ground coffee.

6. A group head according to any one of claims 2 to 5 wherein the diffuser is formed of corrosion-resistant material with high specific heat capacity.

7. A group head according to claim 1 wherein the heater is mounted in the group head bracket for heat conduction from the heater to the group head bracket.

8. A group head according to claim 7 wherein the detachable engagement between the group head bracket and the portafilter is configured for heat conduction from the group head bracket to the portafilter.

9. A group head according to any one of claims 1 to 8 wherein the heater is a resistive heater with a conductive path of electrically resistive material.

10. A group head according to claim 9 wherein, the resistive heater is adjustable for heating the flow of water to a predetermined temperature.

11. A group head according to claim 10 wherein, the predetermined temperature is a user selected temperature.

12. A group head according to any one of claims 9 to 11 further comprising a temperature sensor for feedback control of the resistive heater.

13. A group head according to any one of claims 9 to 12 wherein, the resistive heater is a thick film heater with the electrically resistive material deposited as a thick film on a substrate.

14. A group head according to claim 11 wherein, the thick film heater surrounds at least one section of the conduit.

15. A group head according to claim 13 or 14 wherein, the thick film heater is a disc arranged such that during use, the disc extends in a plane generally parallel to a top surface of the puck.

16. A group head according to claim 15 wherein the conduit has an outlet in the centre of the disc and the channels of the diffuser are configured to radially spread the water flow across the surface of the disc.

17. A group head according to any one of claims 13 to 16 wherein, the thick film heater is configured to heat the water flow through the group head to a temperature between 89° C. and 96° C.

18. A group head according to any one of claims 13 to 16 wherein, the thick film heater is configured to heat the flow of water drawn from a reservoir within an espresso machine, to between 89ºC and 96° C. in less than 10 seconds from activation of the thick film heater.

19. A group head according to any one of claims 1 to 18, wherein the group head includes a chamber defined by internal walls of the group head, the chamber having an aperture for receiving the portafilter, and wherein the heater is mounted to the chamber.

20. An espresso machine comprising a group head according to any one of claims 1 to 19.

21. A method for producing an espresso coffee comprising the steps of:
placing a puck of coffee grounds within a filter basket of a portafilter;
attaching the portafilter to a group head of an espresso machine, the group head having a heater and a conduit for a flow of water to the portafilter;
providing a flow of water through the conduit to the puck of coffee grounds; and,
heating the flow of water through the group head with the heater.

22. A method according to claim 21 wherein, the heater is a resistive heater having a conductive path of electrically resistive material.

23. A method according to claim 22 further comprising the step of adjusting electrical power to the resistive heater to heat the flow of water from the group head to a predetermined temperature.

24. A method according to claim 23 wherein, the predetermined temperature is user selected.

25. A method according to any one of claims 21 to 24 further comprising the step of providing a temperature sensor for feedback control of the resistive heater by a control unit within the espresso machine.

26. A method according to any one of claims 21 to 25 wherein, the heater is formed to surround at least one section of the conduit.

27. A method according to any one of claims 21 to 26 wherein, the resistive heater is a thick film heater with electrically resistive material deposited as a thick film on a substrate.

28. A method according to claim 27 wherein, the thick film heater is formed as a disc extending in a plane generally parallel to a top surface of the puck.

29. A method according to any one of claims 21 to 28 further comprising the step of providing the group head with a flow diffuser adjacent the heater to define a space to spread the flow of water from the conduit across a surface of the heater to enhance conductive heating.

30. A method according to claim 29 wherein the diffuser has a plurality of channels for directing the flow of water across the surface of the heater, the channels having channel walls that abut the surface of the heater for heat conduction into the diffuser.

31. A method according to claim 30, wherein each of the channels is in fluid communication with the conduit for receiving the flow of water, and each of the channels having at least one outlet for fluid communication with the portafilter.

32. A method according to claim 31 further comprising the steps of providing a screen between the outlets of the channels and the portafilter, and arranging the outlets such that the flow of water through the screen to the portafilter has a desired distribution across the puck of ground coffee.

33. A method according to any one of claims 29 to 32 wherein the diffuser is formed of corrosion-resistant material with high specific heat capacity.

34. A method according to any one of claims 21 to 33 further comprising the step of providing a group head bracket for mounting the group head to the espresso machine wherein the heater is mounted in the group head bracket for heat conduction from the heater to the group head bracket.

35. A method according to claim 34 wherein the detachable engagement between the group head bracket and the portafilter is configured for heat conduction from the group head bracket to the portafilter.

36. A method according to any one of claims 21 to 35 further comprising the step of configuring the thick film heater to heat water flowing from the group head to a temperature between 89ºC and 96° C.

37. A method according to claim 36 further comprising the step of configuring the thick film heater to heat the water flowing through the group head to at least 89ºC in less than 10 seconds from activation of the thick film heater.
